(19) United States
(12) Patent Application Publication
(10) Pub. No.: US 2010/0071186 A1
(43) Pub. Date: Mar. 25, 2010

(54) Easily Assembled, Disassembled Fence

(76) Inventor: Edward Mun-Song Son, (US)

Correspondence Address: EDWARD M SON, 2124 WIMBLETON CT, PEARLAND, TX, 77581, US

(21) Appl. No.: 12/563,818

(22) Filed: Sep. 21, 2009

Related U.S. Application Data
(60) Provisional application No. 61/098,788, filed on Sep. 21, 2008.

(51) Int. Cl. B23P 11/00; B23P 19/00

(52) U.S. Cl. 29/426.2; 29/700

(57) ABSTRACT

A new type of a fence design and construction is described whereby a fence configuration is composed of repeating units of fence posts and fence unit sections. Fence posts are composed of a base unit which is embedded into the ground and a post which can be inserted and fastened into this base unit, for ease of construction as well as deconstruction. Unto equally spaced fence posts, pre-manufactured sections of fence unit sections are attached and detached (as well as secured via locking mechanisms) at attachment unit points. The main purpose of this arrangement is the ease of deconstruction in preparation of any natural disasters. A secondary benefit of this arrangement is the ease of initial assembly as well as subsequent reassemblies.

### CROSS-REFERENCE TO RELATED APPLICATIONS

This application claims the benefit of U.S. Provisional Application No. 61/098,788, filed Sep. 21, 2008.

### FIELD OF THE INVENTION

The present invention relates to a new design for a fence that aims to provide protection against damages during any natural disaster, such as hurricane, tornado, or flooding. It provides for an ease of deconstruction so that the fence assembly can be readily disassembled and stored away safely. It also allows for an ease of reconstruction thereafter.

### BACKGROUND OF THE INVENTION

During any natural disaster such as a hurricane, tornado, flooding, or even an earthquake, fences become easy targets of destruction. The reason is that common fences, such as wooden backyard fences, offer very little in terms of solid construction and suffer from greater surface area of wind and water resistance, serving very little more than the simple purpose of enclosing an area. As such they often may be the first and most common structure to undergo damage.

Also it is very possible that, under certain circumstances, broken pieces of fence can cause collateral damage by becoming objects of flying debris.

Moreover, they often become targets of other moving objects, such as falling trees and flying debris.

One way to deal with this situation is to provide a configuration that allows for ease of deconstruction and reconstruction, allowing for safe storage during such natural disasters.

There already exists in the marketplace prefabricated fence units which allow for some degree of ease of assembly. But these products are not designed specifically for the purpose of ready disassemblies and reassemblies. I.e. they are not designed explicitly for the purpose of storage and transport after installations. Moreover there is no way of securing the assembled products via use of a key-locking mechanism since they are not designed for disassemblies in the first place.

### BRIEF DESCRIPTION OF THE INVENTION

The present invention consists of fence posts which can be easily detached and attached to base units embedded into the ground. Thereunto equally spaced repeating pieces of such fence posts, prefabricated units of fence sections (or units) can be easily attached and detached.

Moreover prefabrication of fence parts implies benefits of manufacturing strategies, allowing for mass production and reduction of production cost.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

“Fence unit” refers to precut assembled subsection of the wall of the total fence area which attaches to two separated fence posts, and can be detached for storage. “Fence post” refers to vertical posts which can be firmly attached to the ground and between two of which a fence unit is attached.

“Fence attachment unit” refers to a joining mechanism between a fence unit and a fence post which exists at the junctures of the top and bottom portions of the fence post.

“Base unit” refers to the bottom section of a fence post which is embedded into the ground and into which the top portion of a fence post is inserted and attached.

“Top unit” refers to the top exposed section of a fence post which is attached to the base unit of a fence post.

“Post attachment unit” refers to a joining mechanism between the top and base units of a fence post which allows for tight coupling between the parts.

“Key-locking mechanism” refers to a mechanism used to secure the pieces of the fence attachment unit together, securing it via the mechanism of a key. In this way the fence unit can be secured to adjoining fence posts.

“Lock hole” refers to hole that exists in the pieces of a fence attachment unit serving as receptacle for the key-locking mechanism.

In the drawings:

FIG. 1 shows a fence unit that's been attached to two fence posts.

FIG. 2 shows an enlarged view of the attachment unit between a fence post and a fence unit.

FIG. 3 shows a detailed side view of a fence attachment unit.

FIG. 4 shows a cross sectional view of the fence unit's part of a fence attachment unit.

FIG. 5 shows a top view of the fence unit's part of a fence attachment unit.

FIG. 6 shows a side view of the fence post's part of a fence attachment unit.

FIG. 7 shows a front view of the fence post's part of a fence attachment unit.

FIG. 8 shows a top view of the fence post's part of a fence attachment unit.

FIG. 9 shows an expanded view of the key-locking mechanism for the attachment unit.

FIG. 10 shows the top and base units of a fence post.

FIG. 11 shows the mechanism of the post attachment unit between the top and base units of a fence post.

### DETAILED DESCRIPTION

Embodiments of the present invention are described herein in the context of a design, method, and apparatus for a fence configuration which allows for ease of construction, deconstruction, and storage or transport. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the engineer's specific goals, such as compliance with design-related constraints, and that these specific goals will vary from one implementation to another and from one designer and engineer to another. Moreover, it will be appreciated that such an engineering effort might be complex and time-consuming, but would nevertheless be a routine undertaking of engineering for those of ordinary skill in the art having the benefit of this disclosure.

In accordance with the present invention, the components and/or design elements may be implemented using various types of materials and deviations from the presented design. However, those of ordinary skill in the art will recognize that such deviations may be used without departing from the scope and spirit of the inventive concepts disclosed herein.

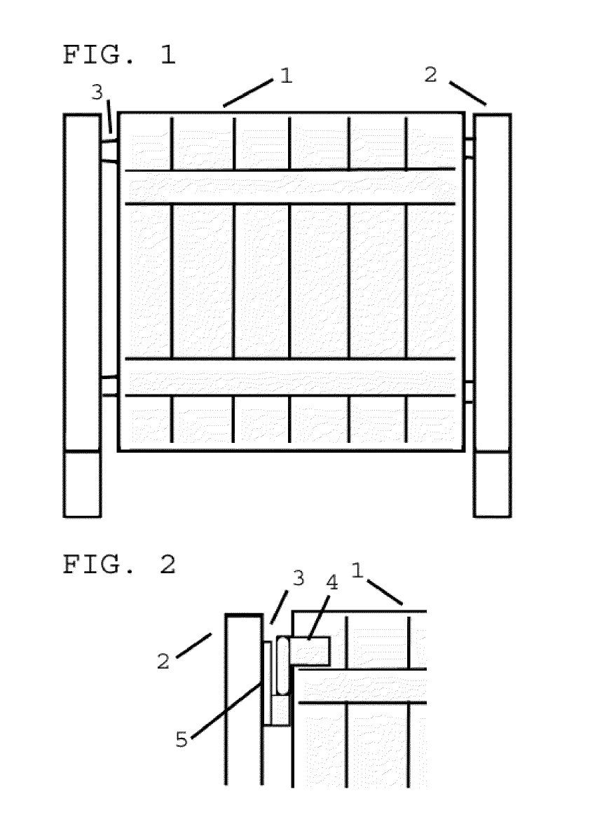

FIG. 1 shows a diagram of a fence unit 1 attached to two fence posts 2. The fence unit 1 is composed of vertical slabs of a fencing material, such as pressure sealed wood or plastic, with optional cross support beams at top and bottom sections. The fence unit 1 is attached to fence posts 2 via separate fence attachment units 3 at four attachment points.

These fence units 1 come in different sizes: i.e. with various numbers of vertical slabs, allowing for variation in width of the fence units 1, in order to be able to properly enclose any given area by a repetition of these fence posts 2 and fence units 1.

FIG. 2 shows a close up view of the fence attachment unit 3. The fence attachment unit 3 is affixed to the fence unit 1 at point 4 and to the fence post 2 at point 5.

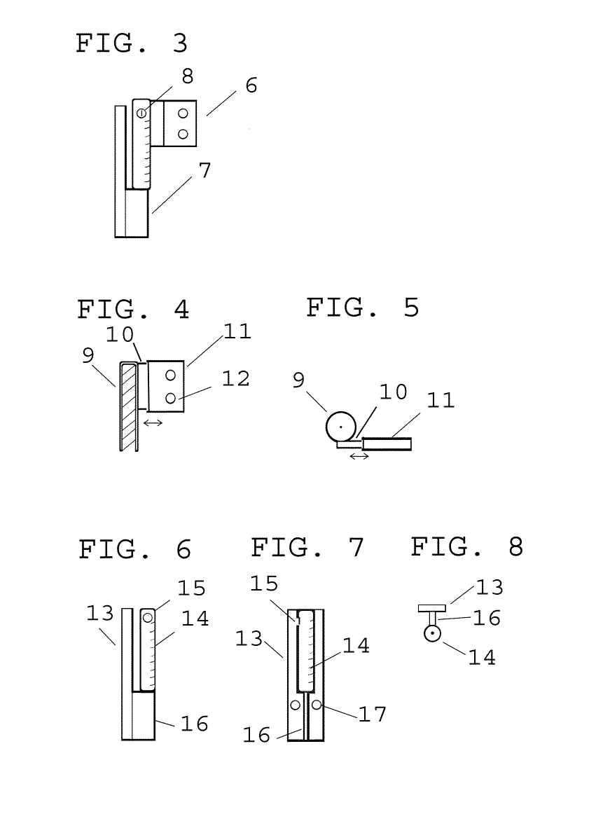

FIG. 3 shows a side view of the fence attachment unit. There are two distinct pieces of the fence attachment unit, piece 6 and piece 7, which are affixed to the fence unit and the fence post respectively. The joining of piece 6 and piece 7 is achieved by inserting a solid tube of piece 6 into the hole of a hollow tube of piece 7. This configuration holds the fence unit and the fence post together while allowing them to rotate with respect to each other. This is important in terms of allowing flexibility to the whole configuration, allowing it to properly enclose non-rectangular, non-geometrically described area of property.

There is also a key-locking mechanism at point 8 which allows the two pieces (6, 7) to lock and prevent their detachment without the use of a key.

Although these locking mechanisms can be positioned at all of the 4 fence attachment unit points between a fence unit and two adjoining fence posts, they only need be available at two diagonally opposite points. For e.g. at upper left and lower right. This is sufficient to prevent removal of the fence units from two adjoining fence posts without the key.

FIG. 4 shows a cross section of the piece of the fence attachment unit that attaches to the fence unit. It is composed of a hollow tube 9 attached to a flat panel 10. This flat panel 10 is inserted into another containing flat panel 11 which is attached to the fence unit via two screws 12. The hollow tube 9 fits over a corresponding solid tube of the piece of the fence attachment unit that attaches to the fence post.

This arrangement of the flat panel 10 and the containing flat panel 11 allows for an adjustment to the total width of the fence attachment unit, for the purpose of achieving a proper fit of the fence unit between fence posts.

FIG. 5 shows a top view of the piece of the fence attachment unit that attaches to the fence unit. It is composed of a hollow tube 9 attached to a flat panel 10 which is then inserted into a containing panel 11.

FIG. 6 shows a side view of the piece of the fence attachment unit that attaches to the fence post. This piece is composed of a solid tube 14 attached to a vertical slab 16, which is attached to a flat panel 13 at perpendicular angle. This metal slab 13 is attached to the fence post.

The solid tube 14 fits into the hollow tube of the piece of the fence attachment unit which attaches to the fence unit and has a corresponding lock hole 15 into which the key-locking mechanism can be inserted.

FIG. 7 shows a front view of the piece of the fence attachment unit that attaches to the fence post. This piece is composed of a solid tube 14 attached to a vertical slab 16, which is attached to a flat panel 13 at perpendicular angle, and also shows the lock hole 15 into which the key-locking mechanism can be inserted. This metal slab 13 is attached to the fence post via two screws 17.

FIG. 8 shows a top view of the piece of the fence attachment unit that attaches to the fence post. This piece is composed of a solid tube 14 attached to a vertical slab 16, which is attached to a flat panel 13 at perpendicular angle. This metal slab 13 is attached to the fence post.

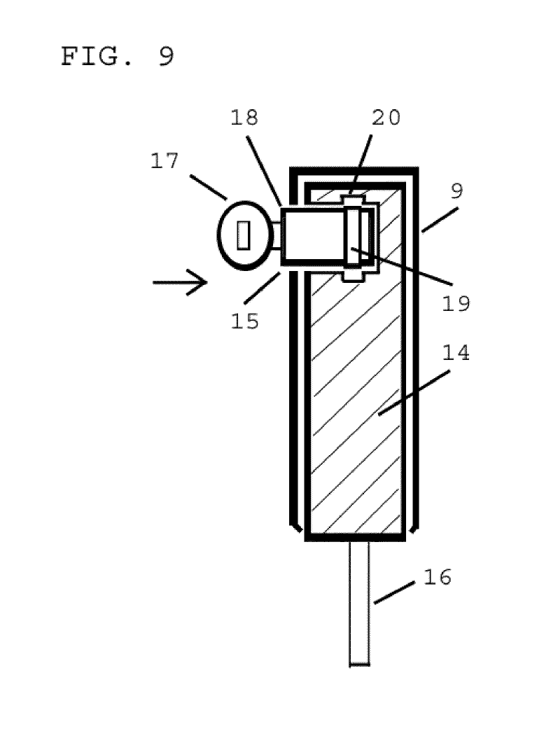

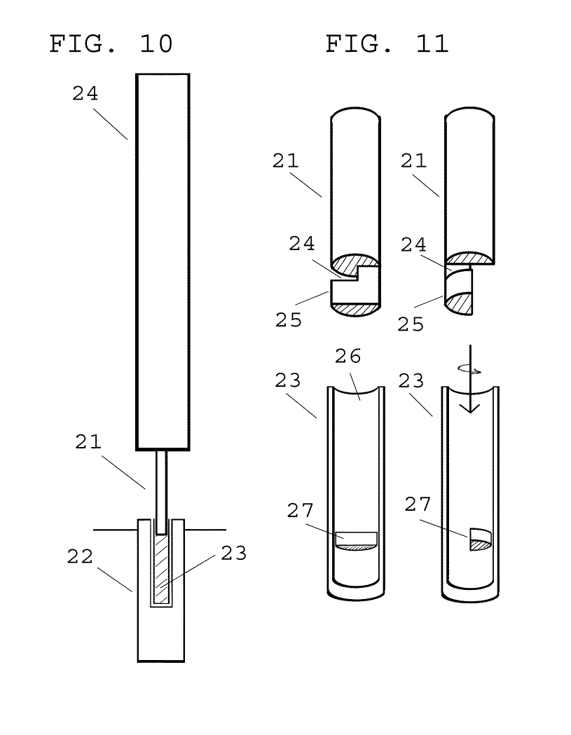

FIG. 9 shows an expanded view of the key-locking mechanism. It is composed of a key 17 and a locking mechanism 18 which is inserted into a lock hole 15 which penetrates into the solid tube 14 and across the hollow tube 9 which covers it. The locking mechanism 18 has a lock release component 19 which releases into a catch groove 20 in the lock hole 15. This action is achieved by the turn of the key 17 allowing the mechanism to lock into place and be released for removal.

This is just one possible mechanism for the key-locking mechanism. Other embodiments may be possible. The purpose of this insert-removable configuration for the key-locking mechanism is to allow a single key to be used against multiple locking mechanisms for a single fence installation.

This way a user can purchase a set of locking mechanisms 18 all with a single matching key 17 to be used for his/her fence installation, while another user purchases a different set of key-locking mechanism pair. Such a combination key-locking mechanisms could be pre-manufactured to allow for a specified number of matching pairs, for e.g. 100.

With a sufficient number of variations in the pairs, the configuration allows for sufficiency in security inversely related to the number of such pairs. But there is no need for absolute security in terms of locking mechanisms with fences, for anyone determined to deconstruct and remove any portion of the fence would not have to resort to breaking the key-lock combination but rather to the use of hammers and saws. Moreover that vulnerability would exist for any fences.

FIG. 10 shows the pieces of a fence post. The top unit 24 has a pole 21 which extends at the bottom and is inserted into a base unit 22 with a corresponding hollow tube 23. This base unit 22 is embedded into the ground by various means, for e.g. being affixed by a concrete mixture poured into a hole in the ground. The base unit 22 itself is not removed during deconstruction of the fence; only the top unit 24.

FIG. 11 shows an expanded view of the post attachment unit. The bottom pole 21 of the top unit is composed of a bottom piece 25 which has half of its material removed and which further has a quarter section 24 removed at its top. The corresponding tube 23 of the base unit has a halved disc 27 which sits at a precisely measured location down its bottom.

The configuration of the bottom piece 25 of the top pole 21 is such that the pole 21 can be inserted all the way into the hollow tube 26 past the halved disc 27 if the pole 21 is rotated just right. After insertion the pole 21 is rotated counterclockwise another 45 degrees allowing the hollowed top section 24 of the pole 21 to lock into place against the disc 27 and thereby preventing the pole 21 from slipping out of the bottom piece 23. The whole mechanism is finely crafted with precision fit of the top unit 21 to the bottom piece 23 allowing rotation to lock the top piece 21 into place. This secures the fence post and when the locking-mechanisms of the fence attachment units are in place at two diagonally opposite locking points, the whole fencing installation achieves a solid, immovable configuration, whereby movement at one attachment point is constrained by the immovability of other attachment points.

While various embodiments of the present invention have been described above, it should be understood that they have been presented by way of example, and not limitation. It will be apparent to persons skilled in the relevant art(s) that various changes in form and detail can be made therein without departing from the spirit and scope of the invention. Thus the present invention should not be limited by any of the above-described exemplary embodiments, but should be defined only in accordance with the specified claims and their equivalents.

The essential claim of the invention is that a fence configuration (regardless of particular shape, design, or material) can be easily disassembled and reassembled for ease of storage and transport. A major benefit of this configuration is to prevent damage during any natural disaster. The configuration also allows the fence units to be securely “locked” during usage. Any method or system that fulfills any or all of these general claims falls within the field and ken of this present invention.

For e.g. other variations of the current invention suggest themselves, including various designs and materials used for the fence, as well as different configurations of assembly and disassembly, as well as different types and mechanisms of the attachment units, as well as different mechanisms for locking or securing the various component pieces, and others. All these variations essentially fall under the same concept of an easily detachable, disassemble-able fence configuration, whose primary purpose is ease of deconstruction, reconstruction, transport, and storage for any period of time.

One concern might be that removing the fence for any short period of time may expose personal property (in the backyard for e.g.) or anywhere else the fencing configuration might be used. The answer to this is simply of course to store away any personal property along with the fence during any natural disaster. Such action would be precautionary anyway and temporary.

The purpose of the present invention was to demonstrate one possible implementation of the underlying spirit and intention of the invention. It is easy to imagine further elaboration of the present demonstration as well as a totally different method or mode of its implementation without departing from the scope and spirit of the claims of the present invention.

1. Method for easily assembling and disassembling a fencing installation or configuration around building properties, both residential and commercial.

2. Method for quickly disassembling a fencing installation for the purpose of storage or transport to avoid damage during natural disasters and for quickly restoring the installation afterwards.

3. Method for preventing damage to and from fencing installations during natural disasters.

4. The design of fencing configuration in claim 1 whereby a fencing installation is composed of precut sections of fencing units consisting of pre-assembled plywood or other comparable material, pre-manufactured fencing posts, and methods for attaching the various subcomponents together.

5. The design of the fencing configuration in claim 4 whereby the fencing posts can be affixed to the ground while allowing for easy removal of the section of post exposed above the ground.

6. The design of the fencing posts in claim 5 whereby the top portion is easily affixed to the bottom unit of the fencing post allowing for secure attachment as well as easy removal.

7. The design of the attachment method in claim 4 of the fencing unit to the fencing post whereby adjustment in width can be made to accommodate slight variations in spacing between fencing posts.

8. The design of the attachment method in claim 4 of the fencing unit to the fencing post whereby adjustment in rotational degree between subcomponents can be made to accommodate different shapes of areas to be enclosed by the fencing installation.

9. The design of the fencing units in claim 4 whereby different widths of units are made available in order to accommodate for various areas of property to be fenced.

10. The design of the attachment method in claim 4 of attaching the fencing unit to the fencing post whereby the attachment of the subcomponents can be secured by a key-locking mechanism.

11. The design of the key-locking mechanism in claim 10 whereby a single key can be used for multiple locking points on the fencing installation while providing for variations of key-lock combination across multiple installations.
